(19) United States
(12) Patent Application Publication
(10) Pub. No.: US 2014/0180864 A1
(43) Pub. Date: Jun. 26, 2014

(54) PERSONALIZED CLOTHING RECOMMENDATION SYSTEM AND METHOD

(71) Applicants: Konstantin Orlov, Santa Clara, CA (US); Marina Naito, Atherton, CA (US); LaiYee Lori Ho, Collegeville, PA (US); Clinton Florez, Fairfield, CA (US); Matthew Scott Zises, San Jose, CA (US)

(72) Inventors: Konstantin Orlov, Santa Clara, CA (US); Marina Naito, Atherton, CA (US); LaiYee Lori Ho, Collegeville, PA (US); Clinton Florez, Fairfield, CA (US); Matthew Scott Zises, San Jose, CA (US)

(73) Assignee: eBay Inc., San Jose, CA (US)

(21) Appl. No.: 13/722,818

(22) Filed: Dec. 20, 2012

(51) Int. Cl. G06Q 30/06

(52) U.S. Cl. CPC G06Q 30/0631
USPC 705/26.7

(57) ABSTRACT

A method and system provides an automated clothes shopping recommendation based on personal style information that defines one or more attributes of clothing articles and/or clothing styles preferred selected by a user, and based on measurement information that defines one or more physical user measurements. On-site direction assistance is provided to the user based on the measurement information through provision of an augmented reality display on a mobile electronic device.

### TECHNICAL FIELD

Example embodiments of the present application generally relate to data processing techniques. For example, the disclosure describes techniques for automatically creating a shopping recommendation for clothing based on a user's style preferences and body measurement information.

### DISCLAIMER

Portions of this disclosure contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

The Internet and the World Wide Web have given rise to a wide variety of on-line retailers that operate virtual stores from which consumers can purchase products (i.e., merchandise, or goods) as well as services. Although the popularity of these on-line retail sites is clearly evidenced by their increasing sales, for a variety of reasons, some consumers may still opt to purchase items in a more conventional manner—i.e., a brick-and-mortar store.

A shopper may, for example, opt to buy clothing only once they have physically tried it on to ensure that the particle article of clothing fits.

Nevertheless, real-life or offline clothes shopping is also associated with frustrations, such as difficulties that may be experienced in finding an appropriate size of clothing article in-store.

### BRIEF DESCRIPTION OF THE DRAWINGS

Various features of the disclosure are illustrated by way of example, and not by way of limitation, in the figures of the accompanying drawings in which:

FIG. 1 is a block diagram depicting a system for providing automated personalized clothing recommendations, where articles of clothing in one or more merchant inventories can automatically be identified and recommended to a user based on user-provided style preferences and body measurement information;

FIG. 2 is a block diagram illustrating an environment for operating a mobile device, according to an example embodiment;

FIG. 3 is a block diagram illustrating a mobile device, according to an example embodiment;

FIG. 4 is a block diagram illustrating a network-based system for use in optimizing shopping lists based on a predetermined objective, according to an example embodiment;

FIG. 5 is a flowchart illustrating a method for automated clothes shopping recommendation, according to an example embodiment;

FIG. 6 is an example user interface that may be used to gather personal style preferences of a user, according to an example embodiment;

FIG. 7 is an example user interface that may be used to gather body measurement information of a user, according to an example embodiment;

FIG. 8 is an example user interface that may be used to gather shopping objectives for a particular shopping recommendation, according to an example embodiment; and

FIG. 9 is a diagrammatic representation of a machine in the example form of a computer system within which a set of instructions for causing the machine to perform any one or more of the methodologies discussed herein may be executed.

### DETAILED DESCRIPTION

An example embodiment of the present disclosure describes data processing techniques for generating personalized clothes shopping recommendations for a user in an automated process. The clothes shopping recommendation may be based on a clothing profile that comprises personal style information defining clothing style preferences of the user and measurement information that indicate physical measurements of the user. A recommendation engine may automatically process inventory data about clothes inventories of merchants, to identify and recommend articles of clothing that accord with or satisfy both the clothing style preferences and the relevant physical measurements of the user. A particular recommendation may be responsive to user input of a particular objective for which shopping is to be done, in which case inventory data may be filtered to exclude articles of clothing irrelevant to the particular objective.

In-store direction may be provided to assist a user to find recommended and/or suitably sized articles of clothing, for example by means of an augmented reality display on which suitably sized articles of clothing may be highlighted. To facilitate ready access by store inventories and/or locations systems to user-specific data, the measurement information may be printed on a visual code for reading at the store. In the following description, for purposes of explanation, numerous specific details are set forth in order to provide a thorough understanding of the various aspects of different embodiments. It will be evident, however, to one skilled in the art, that the present embodiments may be practiced without all of the specific details.

### Gathering Personal Style Information

Embodiments are not limited to mobile devices but could be implemented partly on a mobile device and partly on a laptop or other stationary computing device. An example system may provide a style definition application or style preference gathering functionality to determine personal clothing style preferences of a user as it relates to clothing.

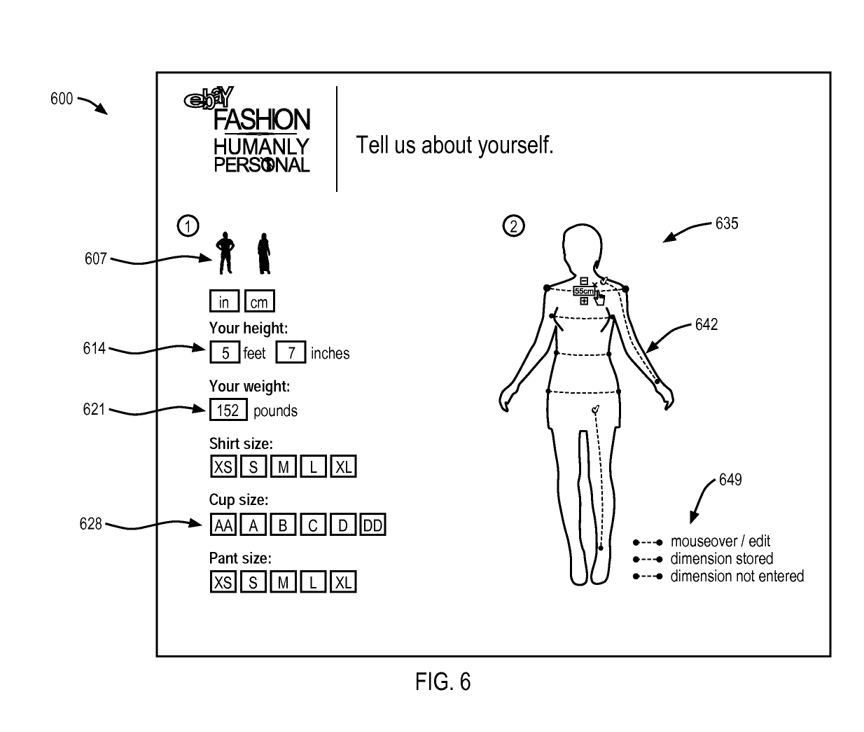

In an example, such a user interface may guide or prompt the user to select particular articles of clothing over other articles of clothing (see, for example, FIG. 6). Such user interface may present different types of clothing articles and, responsive to user-selection of particular articles, refine further articles that are presented for provision of preference indications by the user.

Instead, or in addition, style preferences may be elucidated from the user's existing wardrobe or purchase history. In some examples, clothes shopping history information may be accessed and processed to identify preferences. Such shopping history information may be recognized within an application provided by a publication system such as eBay, Inc,® or may be imported into the eBay app if found within an external application.

In one embodiment, the user preference information, by way of style example data indicating user-selected clothing articles that embody style preferences, may be created by a shopper using an input mechanism (e.g., keyboard, camera, voice input) and then imported into the app. In one example, the user may provide photographic image data of images captured of existing wardrobe articles. The system may then process the image data to recognize particular articles of clothing and associated style attributes (e.g., color, color scheme, material, etc.) to identify style preferences. To assist in identification of the relevant category or type of clothing article of respective wardrobe articles, the user may be asked to identify the contents of each picture, for example by dragging and dropping wardrobe article photos into predefined categories (see again FIG. 6).

The user interface to gather style preference information may also present the user with specific style preference questions or options, for example with option tick boxes to indicate particular brands, colors, formality level, etc, that are to the user's liking.

### Gathering Measurement Information

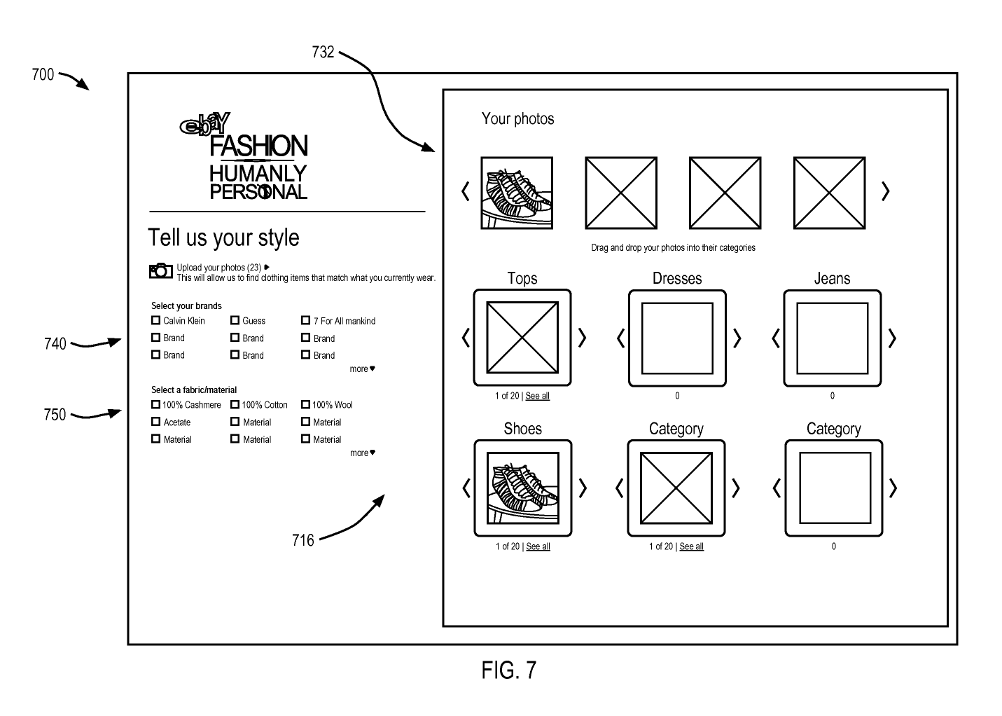

Information about particular physical measurements may be gathered via a corresponding user interface (see, e.g., FIG. 7) forming part of the same application as the style preference UI. In other embodiments, the style and measurement information may be gathered through different portals.

The measurement information user interface may prompt the user to input vital statistics, e.g., via text boxes or the like, to indicate the gender, weight, length, shoe size, etc. of the user. Instead, or in addition, an interactive representation of a human figure may be provided, for example being gender-specific responsive to user indication of their gender (FIG. 7).

By “interactive” it is meant that the figure dynamically changes in appearance in response to user provision of relevant physical measurements. Thus, for example, when the user indicates a particular shoulder width, the width of the figure may shrink or expand accordingly. A user that provides all of the relevant measurements prompted for by the figure's composition (in the example of FIG. 7, these measurements being at least: shoulder width, bust measurement, waist measurement, hips measurement, leg length and arm length), will be viewing a figurine that represents their body profile.

The interactive figure UI may use color-coded data fields to indicate on the figure itself which measurements are outstanding and which have been provided. Note that the physical measurements may comprise both clothes size information (e.g., dress size, pant size, etc.), as well as measurement of particular bodily dimensions.

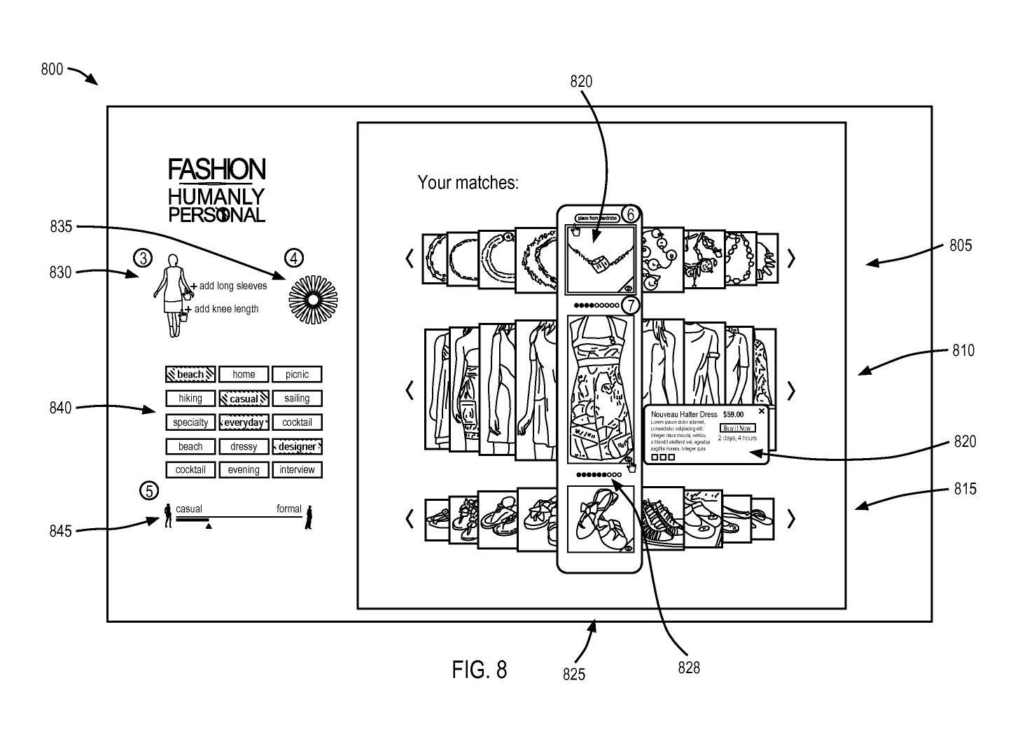

In some embodiments, users may indicate whether or not recommended articles are to their liking, e.g., by one-click liking or disliking of recommended articles, which information may be fed back into the style preference information so that the recommendation engine is effectively self-learning. FIG. 8, for example, shows a user interface where multiple articles are suggested or recommended. Removal by a user of any of the articles from the recommended combination may automatically be registered as a “dislike,” and may be factored into the style preference information.

### Inventory Data

The clothing profile thus composed may be used by a recommendation engine to investigate one or more inventory databases to identify and/or select one or more articles of clothing in an inventory of a merchant that accords with the user's clothing profile, e.g., by matching both her relevant physical measurements and her style preferences.

The particular clothes inventories that are queried may be dependent on the particular application of the system. In some embodiments, the recommendation may be limited to a particular store, online or otherwise, in which case only the inventory of that store is queried. In other embodiments, multiple stores may be considered, in which case multiple associated inventories will be queried.

The recommendation may further be limited in some examples to inventory that is currently in stock, while it may in other embodiments not be so limited. A shopper at a particular store may thus, for example, by execution of a mobile app that embodies these functionalities, request and receive a shopping recommendation for articles of clothing that are of a user-preferred style, that fits the shopper physically, and that is currently available for purchase at that store.

### Shopping Objective Filter

While the shopping recommendation may in some instances be open-ended in that any article of clothing is considered based on the clothing profile of the user, other embodiments may comprise providing a recommendation for a user-provided objective or limited by a user-applied filter. The user may thus specify or provide one or more objectives or filters that are to be applied to the recommendation in advance of providing the recommendation. Instead, or in addition, the user may refine a provided recommendation by applying selective objectives and/or filters to the recommendation, responsive to which the recommendation may be adapted dynamically.

FIG. 8, for example, shows, a number of example shopping objective filters that may be applied. First, particular garment types may be specified, or the constituent pieces of a particular desired outfit may be entered by the user. In the example of FIG. 8, this may be effected by clicking on a human figurine to change garment types until a desired type is displayed. Thereafter, the recommendation engine limits the relevant recommended article to garments of the specified type.

Color filters, or color scheme filters, may also be applied, for example by user interaction with a color wheel user interface device. Such user input determines the particular colors or color schemes that are defined as an objective for the shopping recommendation.

The shopper may further specify the purpose or style of outfit that is desired for recommendation, for example either by selecting one or more verbal definitions of an objective style (see FIG. 8), or, by a sliding scale, defining a level of formality that is to be an objective of a particular recommended outfit or collection.

Another example filter that may be applied to the recommendation query may include price controls, by which the user can specify a price range for individual articles of clothing and/or for an outfit or collection, with the shopping recommendation being dynamically adaptable to remain within the specified price range.

In some examples, the provision of shopping objectives may include the provision of a wardrobe article of the shopper's upon which an outfit or collection is to be based. The user-provided wardrobe article thus forms a seed clothing article upon which a matching or complementary outfit or collection is to be based, being automatically compiled by the recommendation engine based on the seed article, the personal style preferences, and the personal measurement information, with reference to the relevant merchant inventories.

### Recommendation Features

In some embodiments, the method may include generating and displaying a quantified indication of correspondence between the user's preferences and the recommended article, between the recommended article and associated articles in a recommended outfit, or both. In FIG. 8, for example, a match score indicated by a number of colored dots indicates a match score to show how well the recommended articles in a recommended outfit are related, stylistically.

A further feature of providing the shopping recommendation may be that instead of merely displaying one recommended article for each type of article in a recommended outfit, multiple alternative options may be displayed for each article type. See again, for example, FIG. 8, in which the user can scroll through a number of alternatives for each one of three different clothing article types in a set. Again, the user's eventual choice may be recorded and included in style preference information for future clothing recommendation purposes.

The clothes shopping recommendation may in some examples include articles that are already in the shopper's wardrobe. Wardrobe information provided during preference gathering may thus be considered in forming, for example, a collection or outfit recommendation, so that a user's own wardrobe article may in some instances be presented as a member of, or an option for inclusion in, a recommended outfit. Referring again to FIG. 8 as an example, a shopping recommendation for an outfit comprising multiple alternative suggested necklaces, multiple alternative dresses, and multiple alternative pairs of shoes, may include a wardrobe article of the user as at least one of the alternative options in at least one of the three article types.

Note that the shopping recommendation may in some instances comprise the provision of multiple candidate options or suggestions, from which the shopper can interactively mix and match. In such case, the shopping recommendation does not comprise delivery of a firm, set number of recommended articles, but instead serves substantially to reduce the number of different articles from which choices can be made, creating a pool of potential clothing choices that may justify further consideration.

### On-Site Location Finder

Information gathered in composing the user profile may be used at a merchant establishment or other on-site location where the user is physically present as a shopper to assist the shopper in finding articles of interest in-store.

For example, the system may identify the in-store location of articles of clothing that would fit the shopper, based on the associated measurement information, and may provide direction assistance to the shopper to find those articles of clothing.

Provision of the direction assistance may be implemented through a mobile electronic device, such as a mobile phone with processing capacity, e.g., by displaying location indicators on a screen of the mobile device in association with identified or recommended articles. In some embodiments, such location indicators (e.g., a highlight box, colored screen area, dropped pin, or other on-screen indicator) may be provided as a substantially real-time overlay on streaming video captured by a camera of the device. An augmented reality view may thus be displayed on the device, through which the shopper can scan merchandised displayed at the store to find articles of clothing that are sized to fit the shopper.

In some embodiments, such on-site locator functionalities may be provided only to find clothes items that are of suitable size for the shopper, while the shopper may selectively apply filters to limit the clothing articles that are indicated during location finding. A user may, for example, identify a particular brand and article type, say Levi 527 boot-cut jeans, and may then pass the mobile phone's camera over an area where these articles are displayed in-store. The system may then automatically identify those items of interest (e.g., those 527 Levis) that fit the shopper's size.

In such embodiments, the method may comprise generating an information carrier on which the shopper's measurement information is stored, and reading the information carrier on-site at the store, to facilitate the performance of size-matching queries through an inventory of the merchant establishment in question. One example of such an information carrier is a visual code, e.g., a barcode or a Quick Response (QR) code, that may be printed by the shopper at her home computer system and taken by the shopper to the store. At the store, the barcode or QR code may be read by a store computer system to identify matching articles in its inventory.

In other embodiments, on-site location functionality may be combined with provision of automated clothes recommendation, so that a user may, e.g., enter one or more shopping objectives via the mobile phone (e.g., by means of an interface such as that shown in FIG. 7), responsive to which a shopping recommendation may be compiled by the recommendation engine, with in-store collection of properly sized instances of the recommended articles being facilitated by the location finding features described.

Finding the location of respective articles of clothing in order to provide user direction thereto may be accomplished by one or more of a variety of methods. In one example, each article of clothing may be provided with a unique visual identifier or tag, with the direction system being configured to process image data captured by the user's mobile phone in order to recognize respective visual tags. Such visual tags may comprise visual codes, e.g., barcodes or QR codes, or may be visual tags that are typically larger in size and are sized and dimensioned for optical recognition at greater distances than is the case with, e.g., barcodes.

Instead, or in addition, each article of clothing may be provided with a wireless tag, such as an RFID tag, which may be read by a receiver in the user's phone, and/or by a store-wide reader system. In the former instance, the user's phone may read and recognize the respective signals. In the latter instance, map information may be managed by, e.g., a store computer system to map the locations of respective articles of information to a store layout. Such map information may be accessed on the user's phone, e.g., by wireless communication with the store computer system.

The system may comprise tracking the mobile phone's location in the merchant establishment, in order to establish the user's position relative to articles of interest. The tracking system may comprise a global positioning system (GPS), and/or may comprise an indoor positioning system (IPS) that operates through wireless, infrared, or sonic location finding signals.

### Accounting for Brand Size Differences

As mentioned earlier, user measurement information may be entered by specifying specific body dimensions and/or by providing clothing sizes. However, clothes sizes, e.g., dress numbers or classifications of the size of clothes as Large, Medium, etc. (see, e.g., FIG. 6), are often not standardized, so that the same size of, say, a shirt from a particular merchant/brand may be different in true size than shirts indicated by the same size identifier from another brand/merchant.

The method may thus include matching inventory data to user profile information based on true size information of the clothes in the inventory in preference to matching inventory data to user profile information based on brand/merchant provided size classifications. Such true size information for clothes inventory data may be obtained from the respective merchants/brands, and may be incorporated in the inventory data for recommendation purposes.

In one embodiment, the method may include implementing a size provision system in which clothes suppliers provide true size information about respective articles of clothing by generating respective information carriers on which the true size information is stored. For example, the method may include the attachment of a visual code (e.g., bar code or QR code) to respective articles of clothing. Such code may then be scanned by the merchants, to read the true size information for incorporation thereof in the relevant inventory database.

Relationships between respective brand/merchant sizing systems may be identified and applied in refining user measurement information, for example by receiving information about size classifications for articles of clothing of desired size from particular suppliers. For example, the user may specify not merely that his shirt size is Large, but that his shirt size for a particular brand name is Large. Such information may then be adjusted before incorporation in the user's clothing profile to account for a typical sizing classification for the particular brand name.

In some embodiments the user profile and shopping objective filters may be created by the shopper at home, or at some other location, using a computer. In some embodiments, the shopping recommendation is created on, or imported to, the mobile device, either manually by the shopper or automatically, and returned to the mobile device in optimized format. Alternatively, the shopping recommendation may be returned to both the home computer and the mobile device for use as the shopper desires.

### Selected Benefits

One benefit of the described example systems and methods are that it allows for more satisfying on-line shopping. Provision of user measurement information, which may be combined with gathering and collating supplier clothes measurements in increased detail, increases the ability to perform on-line shopping that accounts for the user's particular body profile. Finding items in a store that fit can further be facilitated by on-site direction assistance, which may avoid invariably frustrating and sometimes fruitless in-store searches for articles of clothing that fit.

Provision of recommended alternatives further narrows down the number of options to be considered by the user, based on her own preferences, making on-line shopping a more manageable proposition compared to conventional searches in which the available options returned by a search can be overwhelming.

### Example System

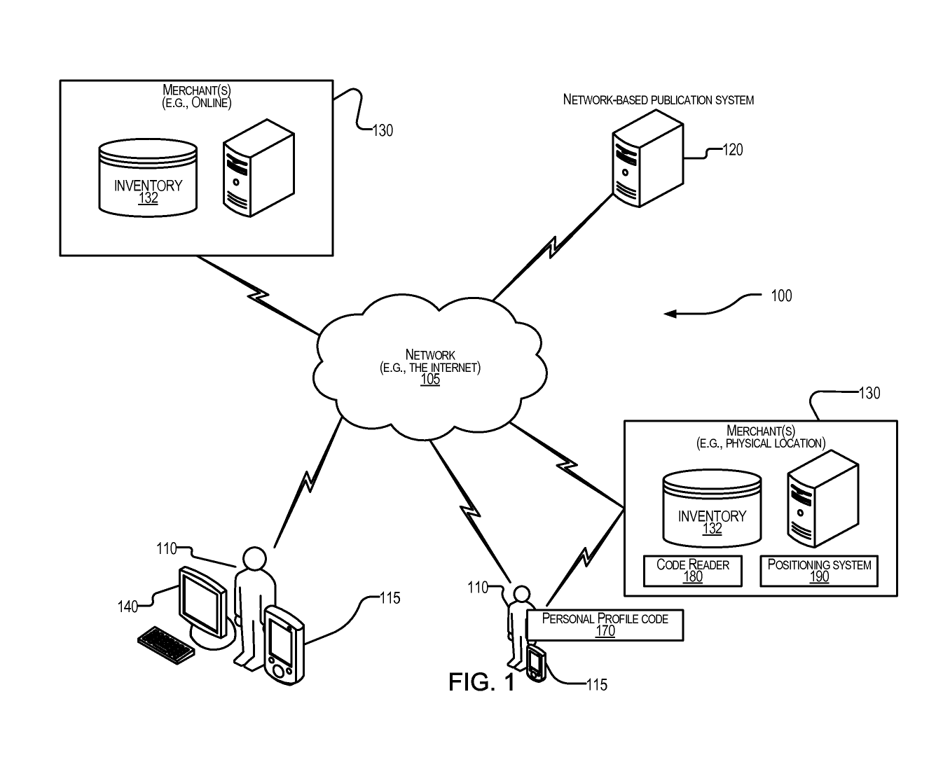

FIG. 1 is a block diagram depicting a system 100 for personalized clothing recommendations, according to an example embodiment. The system 100 can include a shopper 110, a network-based publication system 120 with a search engine, and one or more merchants 130 (and associated merchant systems). The merchants 130 may include exclusively online merchants and/or merchants who do business at a physical location.

In an example, the shopper 110 can connect to the network-based publication system 120 via a client device 115 (e.g., desktop, laptop, smart phone, PDA, or similar electronic device capable of some form of data connectivity). The network-based publication system 120 will receive and process a query from the shopper's 110 client device 115. In examples where direction assistance is to be provided, location information specifying the physical or geographical location of the shopper 110 may be received with the query. For example, if the client device 115 is a mobile device, a GPS unit may inform the client device 115 of its location, such that the location information of the device can be shared with the network-based publication system 120. Other known techniques for deriving location information may be used with both mobile and non-mobile client computing devices, for example, such as desktop computers, etc. For instance, with some embodiments, the location information indicating the location of the shopper 110 may be explicitly specified by the shopper 110, for example, by the shopper 110 interacting with a map.

In an example, the merchant 130 can operate computer systems, such as an inventory system 132 and/or an in-store positioning system 190. The network-based publication system 120 can interact with any of the systems used by merchant 130 for operation of the merchant's 130 retail or service business. In an example, the network-based publication system 120 can work with the inventory system 132 (as well as, in some instances, a point of sale system) to obtain access to inventory available at individual retail locations run by the merchant 130. This inventory information can be used in both generating shopping recommendations, item listings, and selecting and ordering search results served by the network-based publication system 120.

Those merchants 130 that have brick-and-mortar outlets may further include code readers 180 to read personal profile codes 170 that may be carried by the shopper 110 to the merchant 130, the personal profile code containing personal measurement information encoded in, for example, a QR code. In some embodiments, the personal profile code 170 may additionally carry personal style information for automatic consideration by the merchant computer system and/or network-based publication system 120 in formulating a shopping recommendation or suggestion mix.

### Example Operating Environment

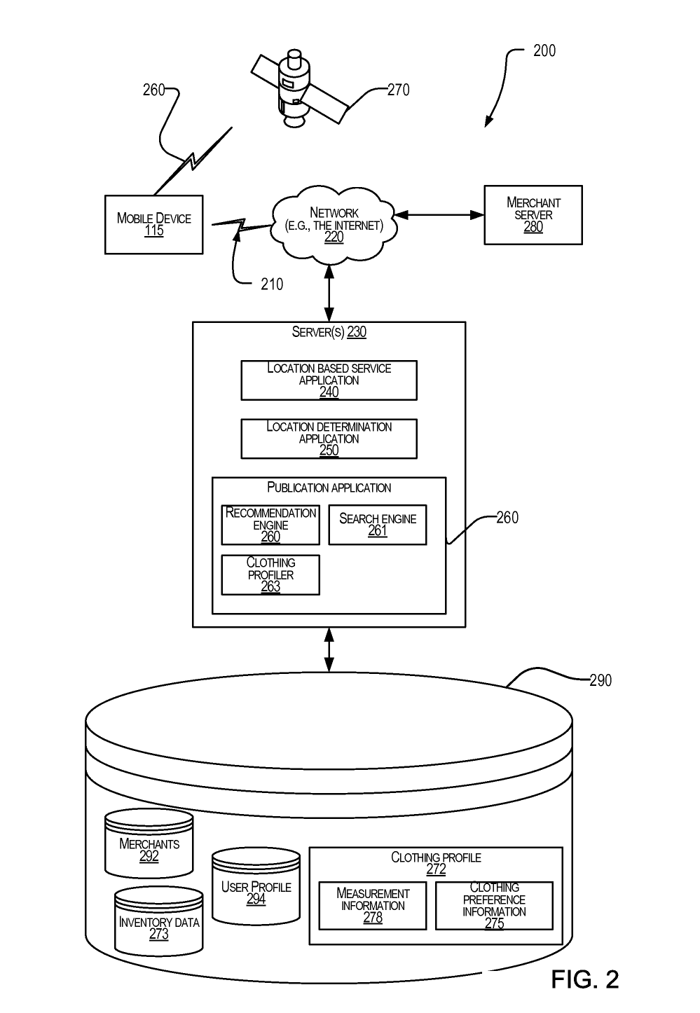

FIG. 2 is a block diagram illustrating an environment 200 for operating client device 115, according to an example embodiment. The environment 200 is an example environment within which methods of automated clothing recommendation can be provided. The environment 200 can include a mobile client device 115, a communication connection 210, a network 220, servers 230, a communication satellite 270 communicating with the mobile client device 115 via satellite link 260, a merchant server 280, and a database 290. The servers 230 can optionally include location based service application 240, location determination application 250, and publication application 255 with search engine 261. The publication application 255 may further provide, when executed, a clothing profiler module or clothing profiler 263 to provide the described functionalities associated with gathering measurement information and personal style information to compose respective clothing profiles for users. The publication application 255 may further provide a recommendation module or recommendation engine 260 to perform automated clothes shopping recommendations, as described.

The database 290 can optionally include merchant databases 292, user profile database 294, and/or inventory data 273. The user profile database 294 may comprise, for each registered user, a clothing profile 272 that includes personal measurement information 278 and personal clothing preference information 275.

The mobile device 115 represents one example device that can be utilized by a shopper to provide input and/or instructions to the clothing profiler 263 and/or the recommendation engine 260, and to receive shopping recommendation information and/or direction assistance from the system 200. The mobile device 115 may be any of a variety of types of devices (for example, a cellular telephone, a PDA, a Personal Navigation Device (PND), a handheld computer, a tablet computer, a notebook computer, or other type of movable device). The mobile device 115 may interface via a connection 210 with a communication network 220. Depending on the form of the mobile device 115, any of a variety of types of connections 210 and communication networks 220 may be used.

For example, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 220 may include a cellular network that has a plurality of cell sites of overlapping geographic coverage, interconnected by cellular telephone exchanges. These cellular telephone exchanges may be coupled to a network backbone (for example, the public switched telephone networks (PSTN), a packet-switched data network, or other types of networks).

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network.

In yet another example, the connection 210 may be a wired connection, for example an Ethernet link, and the communication network may be a LAN, a WAN, the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile device 115. For example, one or more servers 230 may execute location based service (LBS) applications 240, which interoperate with software executing on the mobile device 115, to provide LBSs to a shopper. LBSs can use knowledge of the device's location, and/or the location of other devices and/or retail stores, etc., to provide location-specific information, recommendations, notifications, interactive capabilities, and/or other functionality to a shopper. With some embodiments, the LBS operates in conjunction with the publication application 255 and search engine 261, in particular, to provide direction assistance to the shopper via the mobile device 115, for example to direct the shopper to items of interest in her vicinity via augmented reality-type display. Also, an LBS application 240 can provide location data to a network-based publication system 120, which can then be used to arrange a set of recommendation articles, based on distance and/or travel time between two locations. Knowledge of the mobile device's location, and/or the location of clothing articles of interest, may be obtained through interoperation of the mobile device 115 with a location determination application 250 executing on one or more of the servers 230. Location information may also be provided by the mobile device 115, without use of a location determination application, such as application 250. In certain examples, the mobile device 115 may have some limited location determination capabilities that are augmented by the location determination application 250.

### Example Mobile Device

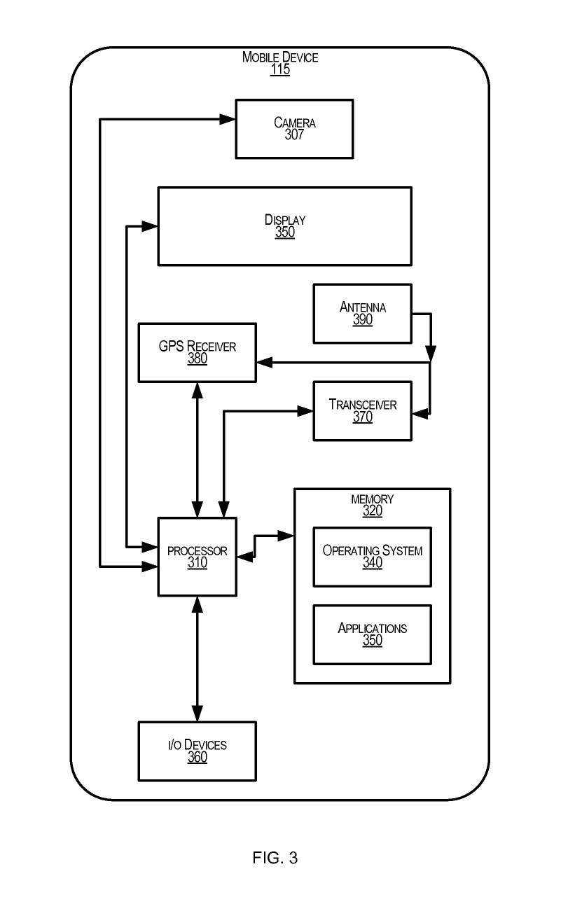

FIG. 3 is a block diagram illustrating the mobile device 115, according to an example embodiment. The mobile device 115 may include a processor 310. The processor 310 may be any of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor 310. The memory 320 may be adapted to store an operating system (OS) 340, as well as application programs 350, and a location enabled application that may provide LBSs to a shopper. The application programs 350 may include one or modules that are configured to perform the functionalities described above regarding clothing profile generation and interactive, dynamic clothes recommendation. The processor 310 may be coupled, either directly or via appropriate intermediary hardware, to a display 343 and to one or more input/output (L/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. In this manner, the connection 210 with the communication network 220 may be established. Further, in some configurations, a GPS receiver 380 may also make use of the antenna 390 to receive GPS signals.

Additional detail regarding providing and receiving location-based services can be found in U.S. Pat. No. 7,848,765, titled “Location-Based Services,” granted to Phillips et al. and assigned to Where, Inc. of Boston, Mass., which is hereby incorporated by reference.

An example geo-location concept discussed within U.S. Pat. No. 7,848,765 is a geofence. A geofence can be defined as a perimeter or boundary around a physical location or mobile object (e.g., a shopper). A geofence can be as simple as a radius around a physical location defining a circular region around the location. However, a geofence can be any geometric shape or an arbitrary boundary drawn on a map. A geofence can be used to determine a geographical area of interest for the calculation of demographics, advertising, presenting search results, or similar purposes. Geofences can be used in conjunction with identifying and presenting search results, as described herein. For example, a geofence can be used to assist in determining whether a shopper (or mobile device associated with the shopper) is within a geographic area of a particular merchant. If the shopper is within a geofence established by the merchant or the publication system, the systems discussed herein can use that information to identify and present recommendation results (e.g., via a mobile device associated with the shopper).

### Example Platform Architecture

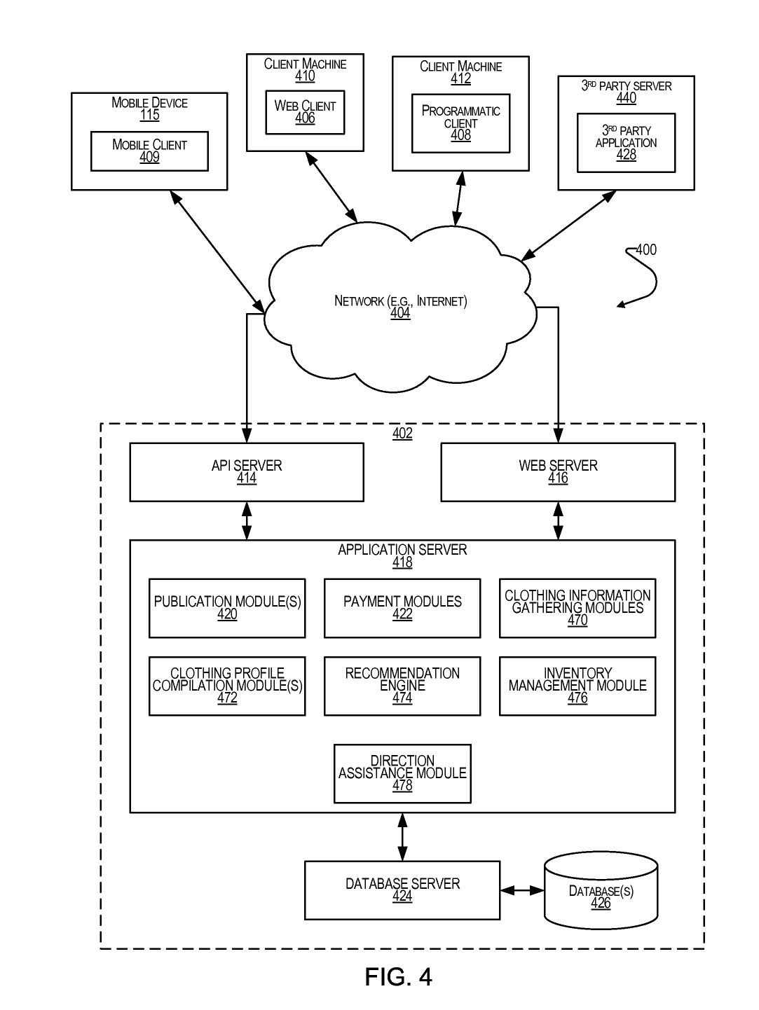

FIG. 4 is a block diagram illustrating a network-based system 400 for providing automated shopper assistance by automated shopping recommendation based on clothing profile information, and/or by providing on-site direction assistance for a shopper to find clothing articles of suitable size, on-site at a merchant establishment, as described more fully herein. The block diagram depicts a network-based system 400 (in the exemplary form of a client-server system), within which an example embodiment can be deployed. A networked system 402 is shown, in the example form of a network-based location-aware publication, advertisement, or marketplace system, that provides server-side functionality, via a network 404 (e.g., the Internet or WAN) to one or more client machines 410, 412. FIG. 4 illustrates, for example, a web client 406 (e.g., a browser, such as the Internet Explorer browser developed by Microsoft Corporation of Redmond, Wash. State) and a programmatic client 408 executing on respective client machines 410 and 412. In an example, the client machines 410 and 412 can be in the form of a mobile device, such as mobile device 115. FIG. 4 shows, for example, a mobile client 409 executing on the mobile device 115.

An Application Programming Interface (API) server 414 and a web server 416 are coupled to, and provide programmatic and web interfaces respectively to, one or more application servers 418. The application servers 418 host one or more publication modules 420 (in certain examples, these can also include search engine modules, commerce modules, advertising modules, and marketplace modules, to name a few); payment modules 422; clothing information gathering modules 470 to gather user measurement information and personal style preferences, e.g. via UIs such as that shown in FIGS. 6-8; clothing profile compilation modules 472 to build respective user clothing profiles based on gathered information; a recommendation engine 474 to generate one or more shopping recommendation responsive to user interaction; an inventory management module 476 to gather/access inventory information from respective merchant inventories and to compile brand size information defining relative clothing size classifications between different brands and/or suppliers; an onsite direction assistance module 478 to guide shopper discovery of suitably sized clothes in-store; and a shopping objective definition module 480 to provide for dynamic and interactive search filter definition by the user. The application servers 418 are, in turn, shown to be coupled to one or more database servers 424 that facilitate access to one or more databases 426. In some examples, the application servers 418 can access the databases 426 directly without the need for a database server 424.

The publication modules 420 may provide a number of publication and search functions and services to shoppers that access the networked system 402. The payment modules 422 may likewise provide a number of payment services and functions to shoppers. The payment modules 422 may allow shoppers to accumulate value (e.g., in a commercial currency, such as the U.S. dollar, or a proprietary currency, such as “points”) in accounts, and then later to redeem the accumulated value for products (e.g., goods or services) that are advertised or made available via the various publication modules 420, within retail locations, or within external online retail venues.

While the various modules described above are shown in FIG. 4 to all form part of the networked system 402, it will be appreciated that, in alternative embodiments, some of the modules may be implemented by services and/or components that are separate and distinct from the networked system 402. For example, the recommendation engine 474 and clothing information gathering modules 470 may in some embodiments be implemented by the mobile device 115, while at least some functionalities of the inventory management module 476 and the direction assistance module 478 may in some embodiments be provided by a merchant computer system or on-site service.

Further, while the system 400 shown in FIG. 4 employs a client-server architecture, the present embodiment is of course not limited to such an architecture, and could equally well find application in a distributed, or peer-to-peer, architecture system, for example. The various modules on application server 418 could also be implemented as standalone systems or software programs, which do not necessarily have networking capabilities.

The web client 406 accesses the various modules on application server 418 via the web interface supported by the web server 416. Similarly, the programmatic client 408 accesses the various services and functions provided by the modules via the programmatic interface provided by the API server 414. The programmatic client 408 may, for example, be a smartphone application.

FIG. 4 also illustrates a third party application 428, executing on a third party server machine 440, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more promotional, marketplace or payment functions that are supported by the relevant applications of the networked system 402. Additionally, the third party website may provide merchants with access to purchase offer modules for configuration purposes. In certain examples, merchants can use programmatic interfaces provided by the API server 414 to develop and implement rules-based recommendation and/or pricing schemes that can be implemented via the respective modules.

### Example Method

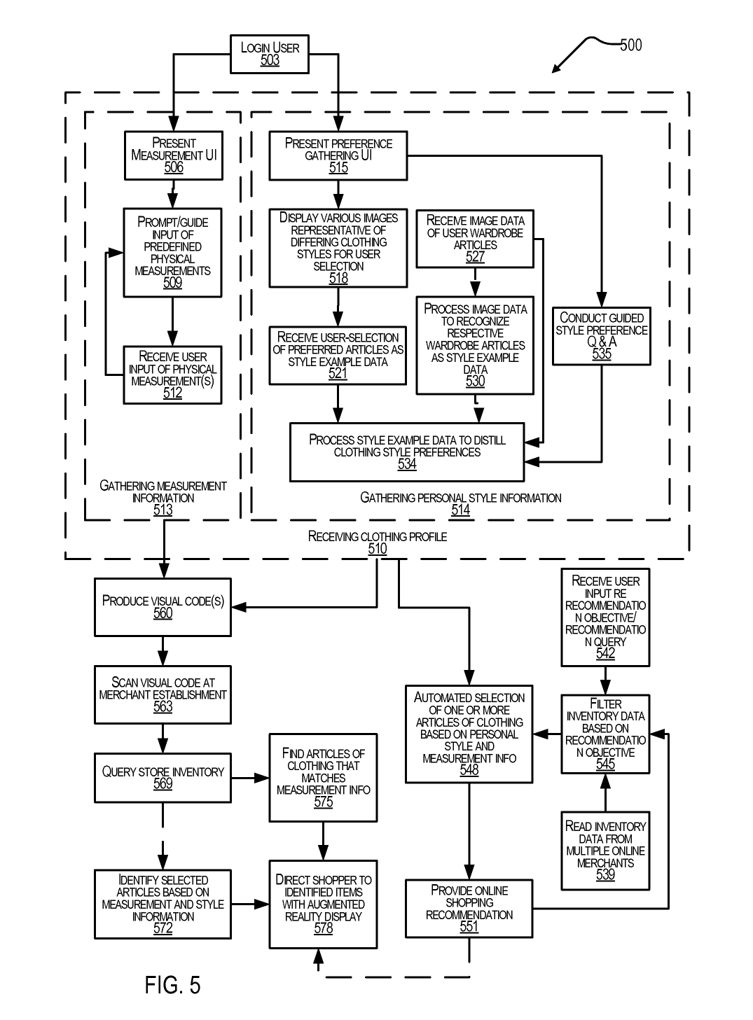

FIG. 5 is a flowchart illustrating a method 500 for providing automated shopping assistance in accordance with an example embodiment. The method 500 may start with logging in a user, at operation 503, to a webpage that provides the described functionalities. Thereafter, measurement information 278 (FIG. 2) may be gathered, in some embodiments, by user interfaces such as those described in example UIs shown in FIGS. 6-8.

A measurement UI may then be presented, at operation 506, an example of which is shown in FIG. 6. The user may be prompted or guided to input predefined physical measurements and/or sizes, at operation 509, responsive to which the user input indicative of the physical measurements may be received, as described earlier, at operation 512. The prompting for physical measurements may be iterative to facilitate gathering of all the relevant size classifications or dimensional measurements. These operations may together comprise gathering measurement information for the user, at operation 513.

In some embodiments, the method 500 may thereafter comprise producing a visual code that carries the user measurement information, e.g., by printing a QR code or the like, at operation 560. When the user thereafter visits a merchant establishment or store to shop for clothes, the printed code may be read at the store, at operation 563, enabling the merchant computer system or other applicable processor to query an inventory of the merchant in question, at operation 569, to identify in-stock articles that fit the user (based on the scanned measurement information) at operation 575. The user may, instead, provide search parameters that limit the type of articles returned as identified in-stock articles, at operation 572, so that in-store direction assistance and item location is based not only on user measurements, but also on user style preferences.

Thereafter, the user may be provided direction assistance, at operation 578, e.g., via merchant system communication with her mobile device 115, to the identified, suitably sized, in-stock clothing articles. As described previously at greater length, such direction assistance may include the display of on-screen location indicators in an augmented reality-type display.

Returning now to the login operation 503, the method 500 may in other embodiments include gathering personal style information, at operation 515, instead of or in addition to gathering the measurement information. This may include presenting an on-screen preference gathering UI (see e.g., FIG. 7), at operation 515. At operation 518, a variety of images representative of different clothing styles and style attributes are displayed to the user, in order to receive, e.g., by user rating or selection of respective images, user input of style example data, at operation 521. At operation 527, user-provided image data is received that indicates existing wardrobe articles owned by the user. These images may be processed, at operation 530, to recognize the particular clothing article type and style attributes represented by the subject of the respective images. In the example UI of FIG. 7, however, the user is provided the option of dragging and dropping wardrobe images to classification areas.

Gathering style preference information may further comprise conducting a guided online style question and answer session, at operation 535, and may also comprise automated auditing or investigation of the user's shopping history from available sources.

At operation 534, the style example data is processed to identify or distill the user's particular personal clothing style preferences. This information is combined with the corresponding measurement information to create a clothing profile for the user, at operation 510.

When user input is received that initiates a recommendation query, at operation 542, e.g., by providing one or more recommendation objectives (e.g., pricing, formality level, brand names, clothing purpose, activity for which an outfit is desired, a seed wardrobe article for which matching articles are to be found, color wheel input, etc.) relevant inventory data from multiple online merchants (or from one or more query-limited merchants) is read, at operation 539, and is filtered, at operation 545, by the recommendation engine based on both the personal style information and the measurement information, as well as on the query parameters, to select, at operation 548, and display to the user one or more articles of clothing that accord with the style, measurements, and query parameters of the user.

The presentation of these selections may comprise provision of an online shopping recommendation, at operation 551, which may be iterative and interactive responsive to user provision of additional criteria or rejection and/or acceptance of one or more recommended clothing articles. As shown in example the recommendation of FIG. 8, the recommendation may comprise presenting a plurality of alternative recommended articles or options for each of a predefined number of article types that together define an outfit, collection, or garment set for which the recommendation query was provided.

The method 500 may include providing direction assistance to the user, at operation 578, should the shopper decide to visit a physical merchant establishment.

In other embodiments, the visual code (e.g., QR code/barcode) produced at operation 560 may include both measurement info and style preferences, in which case the method 500 may include identifying in-stock articles, at operation 572, that not only fit the user physically, but that correspondence to the user's style preferences.

### Example Shopper Interfaces

FIG. 6 illustrates an example measurement gathering interface 600 on a screen of a computer device. The interface 600 comprises a graphical gender selector 607 in which the user can select male or female clothing recommendations.

Height information and weight information can be entered via text box graphical user interface (GUI) elements comprising a height input element 614 and a weight input element 621 respectively.

Clothing size classifications can be entered by selecting one of a number of selection boxes for each clothing article type. Thus, the user can, in area 628 of the interface 600, indicate her shirt size, cup size, and pant size.

More specific dimensional measurements can be inputted via a dynamically responsive doll or human FIG. 635, shown in profile. Predefined measurements may be highlighted on the FIG. 635, in this example providing for shoulder width, chest circumference, waist circumference, hips circumference, and inner leg length.

Each of these measurements may be indicated by a colored, high-contrast line on the figure, the line placement corresponding to the respective measurement dimension. Responsive to input of any measurement via the FIG. 635, the shape of the FIG. 635 may dynamically change to reflect the entered measurement.

In this example, a measurement status may be indicated by color-coding of the measurement lines 642 on the FIG. 635. Thus, in this example, an orange line indicates that measurement which is currently being entered or edited, a green line may indicate that the measurement has previously been stored, and a blue line may show that the corresponding measurement has not yet been entered. Color-coding legend 649 lists these mappings.

FIG. 7 is an example preference gathering user interface 700 through which various style preferences of the user may be gathered, as described earlier.

Photos (e.g., user-provided pictures or stock photos) of existing wardrobe articles may be displayed in top row 732. The user may assist classification of the subject garment category by dragging and dropping the photos of respective wardrobe articles in respective category boxes 716. The category boxes 716 are interactive to allow the user to cycle through all available categories. A particular photo may be categorized by the user in more than one predefined category.

Additionally, style preference choices are provided for selection by associated check boxes in areas 740 and 750, respectively. In this example, choice area 740 provides various brand names for selection, and area 750 for selection of preferred fabrics/materials. Note that these are, of course, only example subject areas that may be polled by providing predefined or randomized options, and that interface 700 may be configured to cover, over time or use, a substantially greater number of style topics.

FIG. 8 is an example recommendation query and report user interface 800.

A shopping recommendation in this example comprises multiple alternative suggestions or recommended alternatives to each of a necklace 805, a dress 810, and a pair of shoes 815. The recommendation in this query was thus for an outfit comprising these three types of clothing article, with a particular necklace 822 from the user's wardrobe having been used as a seed article.

The user may cycle through the respective recommended alternatives to obtain a preview 825 in which the currently selected three alternatives are highlighted in combination and given visual predominance on the interface 800. A match score 828 may be provided for each currently selected article, in this example being represented by a certain number of dots. Responsive to cursor movement over a particular article, an information bubble 820 may fly out, to display information about the article.

The recommendation may be dynamically responsive to a number of query tools, examples of which are shown on the left of the example interface 800.

Thus, a garment selection tool 830 allows quick switching between garment types, while recommendations get updated dynamically. The garment selection tool 830 comprises a human figure (which may be based on the measurement information entered via interface 700) that is conceptually segmented into zones, in order to change garment types for inclusion in the recommended combination for the desired outfit.

A color selector 835 in the example form of a color wheel allows narrowing recommendation to a particular range of colors, or, in some embodiments to particular color schemes.

UI zones 840 and 845 allow broadly defined categories of clothing article type that may be selected to allow the user to tailor the recommendations towards one or other end of a casual-formal sliding scale, and/or a particular purpose for the recommendation query.

One-click swapping of recommended articles with a wardrobe article may be possible, while quick rating of the recommended articles may gather user-feedback for refinement of the user's clothing profile for future recommendations.

### Example Machine

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

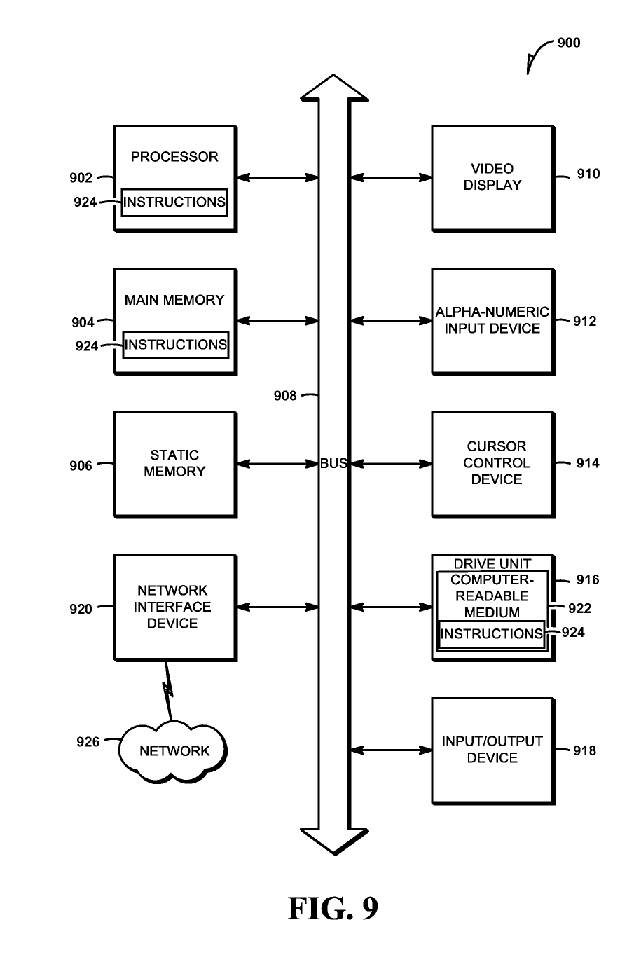

FIG. 9 is a block diagram of a machine in the form of a computer system 900 within which a set of instructions 924 may be executed for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In one embodiment, the machine will be a server computer; however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a display unit 910, an alphanumeric input device 912 (e.g., a keyboard), and a shopper interface (UI) navigation (or cursor control) device 914 (e.g., a mouse). In one embodiment, the display 910, input device 912 and cursor control device 914 are a touch screen display. The computer system 900 may additionally include a machine-readable storage device (e.g., drive unit) 916, a signal generation device 918 (e.g., a speaker), a network interface device 920, and one or more sensors, such as a global positioning system sensor, compass, accelerometer, or other sensor.

The drive unit 916 includes a machine-readable medium 922 on which is stored one or more sets of instructions 924 and data structures (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present embodiment, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although specific example embodiments have been described herein, it will be evident that various modifications and changes may be made to these embodiments without departing from the broader spirit and scope of the embodiments of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, the disclosed subject matter lies in less than all features of a single disclosed embodiment. Thus, the following claims are hereby incorporated into the Detailed Description, with each claim standing on its own as a separate embodiment.

What is claimed is:

1. A system comprising at least one computer processor and computer storage configured to:
receive a clothing profile for a user, the clothing profile comprising
measurement information that defines one or more physical measurements of the user, the one or more physical measurements being relevant to clothing size of one or more types of clothing article, and
personal style information that defines one or more clothing style preferences of the user;
access inventory data that indicates attributes of respective articles of clothing in an inventory of a merchant;
provide a recommendation engine to identify from the inventory one or more articles of clothing based at least in part on both the physical measurement information and the personal style information of the user; and
provide a shopping recommendation for the user, the shopping recommendation including the one or more identified articles of clothing.

2. The system of claim 1, further being configured to:
access style example data that indicates multiple user-selected example clothing articles that each embody at least some clothing style preferences of the user; and
generate the personal style information by automated analysis of the style example data.

3. The system of claim 1, further being configured to provide a preference gathering user interface on a client computer device to prompt user input indicative of the one or more clothing style preferences comprising at least one of: brand name preferences, color preferences, color combination preferences, clothing material preferences, clothing article type preferences, and preferences in formality of clothing.

4. The system of claim 1, further being configured to provide a measurement gathering user interface, to prompt user input of the measurement information, the measurement gathering user interface comprising a representation of a human figure that is dynamically responsive to input of measurement information.

5. The system of claim 1, further comprising a code reading module to receive at least the measurement information by reading and decoding a visual code at a store where the user is present.

6. The system of claim 1, further being configured to limit the shopping recommendation to articles that are presently available for delivery by the merchant.

7. The system of claim 6, wherein the inventory data is for a merchant establishment at which the user is physically present, the system further being configured to provide direction assistance to the user, to facilitate user-location in the merchant establishment of the one or more identified articles of clothing.

8. The system of claim 7, wherein the system is configured to provide the direction assistance by displaying one or more location indicators on a portable electronic device carried by the user.

9. The system of claim 8, wherein the system is configured to provide an augmented reality display in which at least one of the identified articles of clothing is pinpointed substantially in real-time by a respective location indicator in a streaming video display on a screen of the portable electronic device.

10. The system of claim 1, wherein the recommendation engine is further configured to compose a recommended outfit that comprises a plurality of coordinated articles of clothing automatically selected based at least in part on the clothing profile, and to include the recommended outfit in the shopping recommendation.

11. The system of claim 10, further being configured to receive a clothing objective from the user, and to compose the recommended outfit based at least in part on the clothing objective by excluding articles of inventory clothing that conflict with the clothing objective.

12. A system comprising at least one computer processor and computer storage configured to:
receive measurement information that defines one or more user measurements related to clothing size for a user; and
in an automated process based at least in part on the measurement information, identify one or more candidate articles of clothing that are present in an inventory of a merchant, each candidate article of clothing being of a size that matches the one or more user measurements.

13. A method comprising:
receiving a clothing profile for a user, the clothing profile comprising
measurement information that defines one or more physical measurements of the user, the one or more physical measurements being relevant to clothing size of one or more types of clothing article, and
personal style information that defines one or more clothing style preferences of the user;
accessing inventory data that indicates attributes of respective articles of clothing in an inventory of a merchant;
selecting from the inventory, in an automated process performed by one or more processors, one or more articles of clothing based at least in part on both the physical measurement information and the personal style information of the user; and
providing a shopping recommendation for the user, the shopping recommendation including the one or more selected articles of clothing.

14. The method of claim 13, further comprising:
receiving style example data that indicates multiple user-selected example clothing articles that each embody at least some clothing style preferences of the user; and
generating the personal style information by automated analysis of the style example data.

15. The method of claim 14, wherein receiving the style example data comprises receiving user-provided image data, the method further comprising processing the image data to recognize one or more user wardrobe articles to form part of the style example data.

16. The method of claim 13, further comprising providing a preference gathering user interface on a computer device to prompt user input indicative of the one or more clothing style preferences comprising at least one of: brand name preferences, color preferences, color combination preferences, clothing material preferences, clothing article type preferences, and preferences in formality of clothing.

17. The method of claim 13, further comprising providing a measurement gathering user interface on a computer device, to prompt user input of the measurement information, the measurement gathering user interface comprising a representation of a human figure that is dynamically responsive to input of measurement information.

18. The method of claim 13, further comprising receiving at least the measurement information by reading and decoding a visual code at a store where the user is present.

19. The method of claim 13, further comprising limiting the inventory data to currently available inventory, the shopping recommendation therefore including no articles of clothing that are not immediately available for delivery by the merchant.

20. The method of claim 19, wherein the inventory data is for a merchant establishment at which the user is physically present, the method further comprising providing direction assistance to the user, to facilitate user-location in the merchant establishment of the one or more selected articles of clothing.

21. The method of claim 20, wherein the providing of the direction assistance comprises display of one or more location indicators on a portable electronic device carried by the user.

22. The method of claim 21, wherein the providing of the direction assistance comprises an augmented reality display in which at least one of the selected articles of clothing is pinpointed substantially in real-time by a respective location indicator in a streaming video display on a screen of the portable electronic device.

23. The method of claim 13, which further comprises composing a recommended outfit that comprises a plurality of coordinated articles of clothing automatically selected based at least in part on the clothing profile, and including the recommended outfit in the shopping recommendation.

24. The method of claim 23, further comprising receiving a clothing objective from the user, the composing of the recommended outfit being based at least in part on the clothing objective by excluding articles of inventory clothing that conflict with the clothing objective.

25. The method of claim 13, wherein the inventory comprises articles of clothing in respective inventories of multiple competing online merchants.

26. A method comprising:
receiving measurement information that defines one or more user measurements related to clothing size for a user; and
in an automated process that is performed by one or more processors and that is based at least in part on the measurement information, identifying one or more candidate articles of clothing that are present in an inventory of a merchant, each candidate article of clothing being of a size that matches the one or more user measurements.

27. A machine-readable storage device storing instructions for a machine to:
receive a clothing profile for a user, the clothing profile comprising
measurement information that defines one or more physical measurements of the user, the one or more physical measurements being relevant to clothing sizes of one or more corresponding types of clothing article, and
personal style information that defines one or more user-preferred attributes of clothing articles and/or clothing styles;
access inventory data that indicates attributes of respective articles of clothing available in an inventory of a merchant;
provide a recommendation engine to identify in the inventory, based at least in part on the measurement information and the personal style information of the user, one or more selected articles of clothing that substantially fit the clothing profile of the user; and
provide a shopping recommendation for the user, the shopping recommendation including the one or more selected articles of clothing.

28. A machine-readable storage device storing instructions for a machine to:
receive measurement information that defines one or more user measurements related to clothing size for a user; and
in an automated process based at least in part on the measurement information, identify one or more candidate articles of clothing that are present in an inventory of a merchant, each candidate article of clothing being of a size that matches the one or more user measurements.
